(19) United States
(12) Patent Application Publication
(10) Pub. No.: US 2025/0310636 A1
(43) Pub. Date: Oct. 2, 2025

(54) DETECTION SYSTEM, DETECTION METHOD, AND NON-TRANSITORY COMPUTER READABLE MEDIUM

(71) Applicant: NEC Corporation, Minato-ku, Tokyo (JP)

(72) Inventors: Misuzu SHINGAI, Tokyo (JP); Katsuya NAKASHIMA, Tokyo (JP); Honami SUZUKI, Tokyo (JP); Takeo TAMURA, Tokyo (JP); Masatoshi SUGISAWA, Tokyo (JP); Shinji KUBOTANI, Tokyo (JP)

(73) Assignee: NEC Corporation, Minato-ku, Tokyo (JP)

(21) Appl. No.: 18/864,040

(22) PCT Filed: May 9, 2023
(86) PCT No.: PCT/JP2023/017486

§ 371 Date: Nov. 8, 2024

(30) Foreign Application Priority Data
May 26, 2022 (JP) 2022-085727

(51) Int. Cl. H04N 23/60; G06V 10/14; G06V 10/40; G06V 10/98; G06V 40/10; G06V 40/16; G06V 40/60; G06V 40/70

(52) U.S. Cl. CPC H04N 23/64; G06V 10/40; G06V 10/993; G06V 40/11; G06V 40/168; G06V 40/172; G06V 40/60; G06V 40/70; G06V 10/14

(57) ABSTRACT

A detection system according to an aspect of the present disclosure includes a face detection means, an area setting unit, a hand detection unit, and an output unit. The face detection means is configured to detect a face of a subject from an image obtained by photographing the subject. The area setting unit is configured to set, in a case where the face detection means has detected the face of the subject, a hand detection area around an area including the face of the subject. The hand detection unit is configured to detect a hand present in the hand detection area from the image obtained by photographing the subject. The output unit is configured to output information about the face of the subject detected by the face detection means and information about the hand of the subject detected by the hand detection unit.

### TECHNICAL FIELD

The present disclosure relates to a detection system, a detection method, and a non-transitory computer readable medium.

### BACKGROUND ART

Various technologies for acquiring biometric information of users in, for example, departure/immigration examinations have been disclosed. For example,

Patent Literature 1 discloses a personal identification input apparatus in which a face image and a fingerprint image are taken by a camera and a fingerprint sensor, respectively.

### CITATION LIST

### Patent Literature

Patent Literature 1: Japanese Unexamined Patent Application Publication No. 2004 062846

### SUMMARY OF INVENTION

### Technical Problem

In the personal identification apparatus disclosed in Patent Literature 1, the person to be identified, i.e., the person whose face image and fingerprint image are to be taken, needs to pay attention to both a camera that takes the face image and a fingerprint sensor that takes the fingerprint image. Therefore, there has been a problem that the subject feels troubled caused by the above matter.

The present disclosure has been made in order to solve such a problem, and an object thereof is to provide a detection system, a detection method, and a non-transitory computer readable medium capable of acquiring biometric information by which the subject can be authenticated while reducing the burden on the subject.

### Solution to Problem

A detection system according to an aspect of the present disclosure includes a face detection unit, an area setting unit, a hand detection unit, and an output unit. The face detection unit is configured to detect a face of a subject from an image obtained by photographing the subject. The area setting unit is configured to set, in a case where the face detection unit has detected the face of the subject, a hand detection area around an area including the face of the subject. The hand detection unit is configured to detect a hand present in the hand detection area from the image obtained by photographing the subject. The output unit is configured to output information about the face of the subject detected by the face detection unit and information about the hand of the subject detected by the hand detection unit.

In a detection method according to an aspect of the present disclosure, a computer performs the following processes. The computer detects a face of a subject from an image obtained by photographing the subject. The computer sets, upon detecting the face of the subject, a hand detection area around an area including the face of the subject. The computer detects a hand present in the hand detection area. The computer outputs information about the detected face and information about the detected hand.

A non-transitory computer readable medium according to an aspect of the present disclosure is a non-transitory computer readable medium storing a program for causing a computer to perform the following processes. The computer detects a face of a subject from an image obtained by photographing the subject. The computer sets, upon detecting the face of the subject, a hand detection area around an area including the face of the subject. The computer detects a hand present in the hand detection area. The computer outputs information about the detected face and information about the detected hand.

### BRIEF DESCRIPTION OF DRAWINGS

FIG. 1 is a block diagram showing a configuration of a detection system according to a first example embodiment;

FIG. 2 is a flowchart showing processes performed by the detection system according to the first example embodiment;

FIG. 3 is a block diagram showing a configuration of a detection system according to a second example embodiment;

FIG. 4 is a block diagram showing a configuration of a detection apparatus according to the second example embodiment;

FIG. 5 is a flowchart showing processes performed by the detection apparatus according to the second example embodiment;

FIG. 6 is a schematic diagram showing an example of an image obtained by photographing a subject according to the second example embodiment;

FIG. 7 is a schematic diagram showing an example of an image obtained by photographing a subject according to the second example embodiment;

FIG. 8 is a schematic diagram showing an example of an image obtained by photographing a subject according to the second example embodiment;

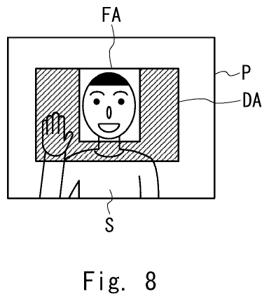

FIG. 9 is a schematic diagram showing an example of an image obtained by photographing a subject according to the second example embodiment;

FIG. 10 is a block diagram showing a configuration of a detection apparatus according to a third example embodiment;

FIG. 11 is a flowchart showing processes performed by a detection system according to the third example embodiment;

FIG. 12 is a flowchart showing processes performed by a detection system according to a fourth example embodiment; and

FIG. 13 is a block diagram showing an example of a hardware configuration of a computer.

### EXAMPLE EMBODIMENT

### First Example Embodiment

### Configuration of Detection System

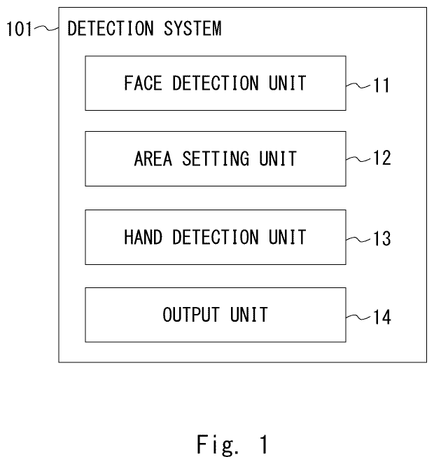

A detection system according to a first example embodiment will be described hereinafter in detail with reference to the drawings. FIG. 1 is a block diagram showing a configuration of a detection system according to the first example embodiment.

A detection system 101 according to this example embodiment detects a face and a hand of a subject from an image obtained by photographing the subject, and outputs information about the detected face and information about the detected hand.

The detection system 101 includes a face detection unit 11, an area setting unit 12, a hand detection unit 13, and an output unit 14.

Note that the information about the face may be, for example, a part of the image obtained by photographing the subject corresponding to the detected face, i.e., the image of the detected face. Alternatively, the information about the face may be features extracted from the aforementioned image.

Further, the information about the hand may be, for example, a part of the image obtained by photographing the subject corresponding to the detected hand, i.e., the image of the detected hand. Alternatively, the information about the hand may be features extracted from the aforementioned image.

The face detection unit 11 detects the face of the subject from the image obtained by photographing the subject.

In a case where the face detection unit has detected the face of the subject, the area setting unit 12 sets a hand detection area around an area including the face of the subject.

Note that in a case where the hand detection area is set, the detection system 101 may guide the subject to take such a posture that his/her hand is shown (i.e., positioned) in the hand detection area.

The hand detection unit 13 detects the hand present in the hand detection area from the image obtained by photographing the subject.

The output unit 14 outputs information about the face detected by the face detection unit 11 and information about the hand detected by the hand detection unit 13.

### Processing of Detection System

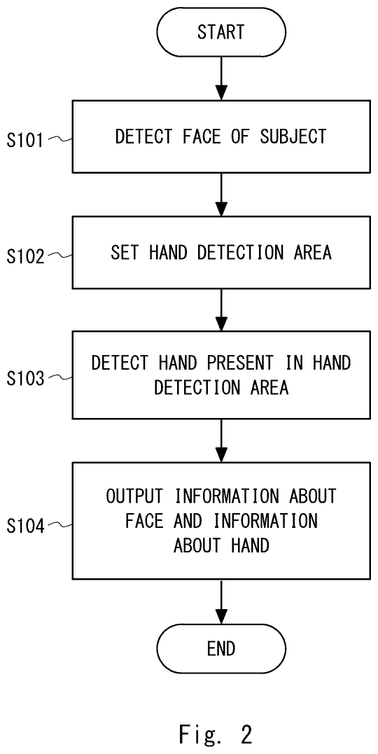

Next, processes, i.e., a method, performed by the detection system according to the first example embodiment will be described in detail with reference to the drawings. FIG. 2 is a flowchart showing processes performed by the detection system according to the first example embodiment. Note that in the following description, FIG. 1 will be referred to as appropriate.

Firstly, the face detection unit 11 detects the face of a subject from an image obtained by photographing the subject (Step S101). The face detection unit 11 provides information about the detected face of the subject to the area setting unit 12 and the output unit 14.

Next, the area setting unit 12 sets a hand detection area around an area including the face of the subject (Step S102). The area setting unit 12 provides information about the set hand detection area to the hand detection unit 13.

Next, the hand detection unit 13 detects a hand present in the hand detection area (Step S103). The hand detection unit 13 provides information about the detected hand of the subject to the area setting unit 12 and the output unit 14.

Lastly, the output unit 14 outputs the information about the face and the information about the hand, and the detection system 101 finishes the series of processes.

As described above, the detection system 101 according to this example embodiment detects the face of a subject from an image obtained by photographing the subject, and detects a hand of the subject in a hand detection area set around an area including the face of the subject.

According to the above-described configuration, the subject does not need to pay attention to a plurality of photographing apparatuses. Therefore, the detection system 101 can prevent the subject from feeling troublesome. That is, the detection system 101 according to this example embodiment can reduce the burden on the subject.

### Second Example Embodiment

### Configuration of Detection System

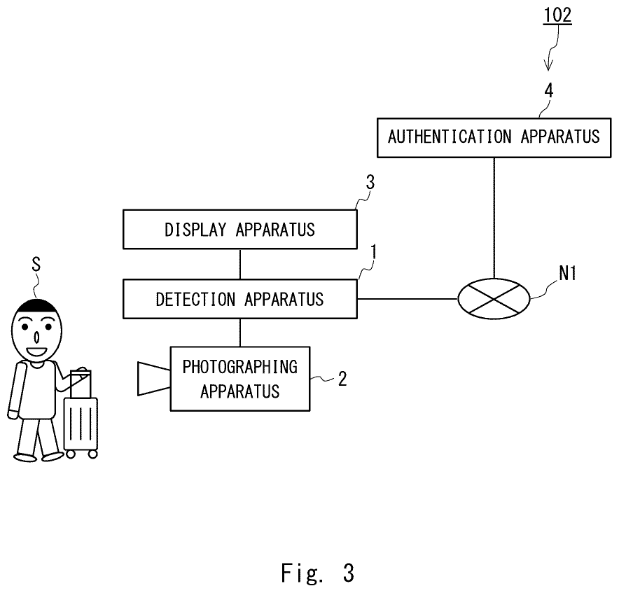

A detection system according to a second example embodiment will be described hereinafter in detail with reference to the drawings. Firstly, a configuration of a detection system according to the second example embodiment will be described. FIG. 3 is a block diagram showing a configuration of a detection system according to the second example embodiment.

A detection system 102 is a system that performs biometric authentication of a subject who uses a facility such as an airport or a port. The detection system 102 includes, as main components, a detection apparatus 1, a photographing apparatus 2, a display apparatus 3, and an authentication apparatus 4. The detection apparatus 1 and the authentication apparatus 4 are connected to each other through a network N1 so that they can communicate with each other. Note that the network N1 may be a telephone line, a wide area network, or a local area network.

The detection apparatus 1 is installed, for example, in an airport, and acquires biometric information of a subject S, who is a passenger. The detection apparatus 1, which has acquired the biometric information of the subject S, provides the acquired biometric information to the authentication apparatus 4. Upon receiving the biometric information from the detection apparatus 1, the authentication apparatus 4 authenticates the received biometric information. The authentication apparatus 4, which has performed the authentication, provides information about the result of the authentication to the detection apparatus 1. Upon receiving the information about the result of the authentication from the authentication apparatus 4, the detection apparatus 1 performs processing, such as a process for permitting the subject S to pass through a gate or the like, according to the received information.

More specifically, the detection apparatus 1 acquires an image obtained by photographing the subject S and detects, as biometric information for authenticating the subject S, information about the face of the subject S and information about the hand of the subject S from the acquired image. Note that the detection system 102 according to this example embodiment outputs an image of the face of the subject S as information about the face of the subject S. Further, the detection system 102 according to this example embodiment outputs an image of the hand of the subject S as information about the hand of the subject S.

However, the information about the face of a subject and the information about the hand thereof, which the detection system according to the present disclosure outputs, are not limited to the image of the face of the subject and the image of the hand thereof, respectively. For example, the detection system according to the present disclosure may output features of the face of a subject as information about the face of the subject. Further, the detection system according to the present disclosure may output an image of an iris of an eye of the subject or features thereof. Further, the detection system according to the present disclosure may output features of a hand of the subject as information about the hand of the subject. Further, the detection system according to the present disclosure may output an image of a fingerprint of the subject or features thereof. Further, the detection system according to the present disclosure may output an image of veins on a palm of the subject or features thereof. That is, the information about the face of the subject and the information about the hand of the subject output by the detection system according to the present disclosure may be any information by which the subject can be authenticated.

The photographing apparatus 2 photographs the subject S based on the control by a photographing control unit 16. Then, the photographing apparatus 2 provides an image obtained by photographing the subject S to the photographing control unit 16. Note that although the photographing apparatus 2 according to this example embodiment photographs the subject S at predetermined intervals, the configuration of the photographing apparatus 2 is not limited to this example. For example, the photographing apparatus 2 may be configured to photograph the subject S every time the detection apparatus 1 completes a predetermined process. Further, although the photographing apparatus 2 according to this example embodiment is configured with one camera, the configuration of the photographing apparatus 2 is not limited to this example, and may be configured with, for example, two or more cameras.

The photographing apparatus 2 may be a camera that performs photographing by detecting light in a visible light range, or a camera that performs photographing by detecting light in a non-visible light range. For example, in a case where the information about the hand of the subject S includes an image of veins on a palm of the subject S or features thereof, the photographing apparatus 2 may photograph the subject S by detecting light in an infrared light range.

The display apparatus 3 displays a guidance image for the subject S. For example, the display apparatus 3 may display an image for notifying the subject S that photographing will be performed in order to acquire his/her biometric information.

Further, in a case where a hand detection area (which will described later) is set, the display apparatus 3 may also display a reference posture image for urging (or requesting) the subject S to take a predetermined posture.

More specifically, the display apparatus 3 may acquire an image showing the range of the hand detection area and an image obtained by photographing the subject S from the detection apparatus 1. The display apparatus 3 may display these images in such a manner that they are superimposed on each other. Then, the display apparatus 3 may notify the subject S to take such a posture that his/her hand is shown (i.e., positioned) in the hand detection area.

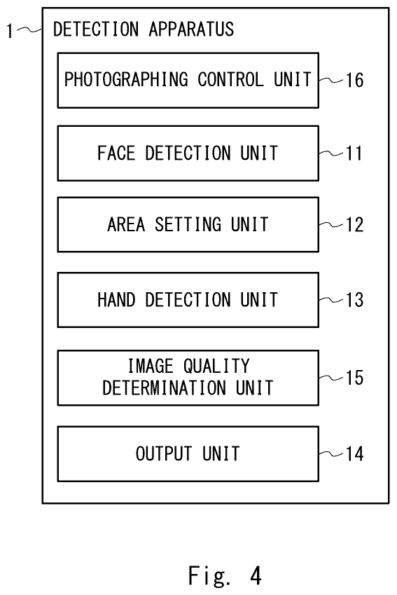

Next, the detection apparatus 1 will be further described with reference to FIG. 4. FIG. 4 is a block diagram showing a configuration of the detection apparatus 1 according to the second example embodiment. The detection apparatus 1 includes, as main components, a face detection unit 11, an area setting unit 12, a hand detection unit 13, an output unit 14, an image quality determination unit 15, and a photographing control unit 16. These components included in the detection apparatus 1 are connected to each other as appropriate so that the detection apparatus 1 can carry out the functions described in the present disclosure.

The photographing control unit 16 controls the photographing apparatus 2. The photographing control unit 16 may determine, for example, a timing at which the photographing apparatus 2 starts photographing and/or a timing at which the photographing apparatus 2 finishes the photographing. The photographing control unit 16 acquires an image taken by the photographing apparatus 2 and provides the acquired image to the face detection unit 11.

The photographing control unit 16 may make the photographing apparatus 2 start photographing, for example, in a case where a sensor (not shown) detects that a subject is present in a photographing possible range of the photographing apparatus 2. Further, the photographing control unit 16 may make the photographing apparatus 2 finishes the photographing in a case where the detection apparatus 1 outputs an image of the face of the subject and an image of a hand of the subject. By the above-described configuration, the detection apparatus 1 can shorten the time during which the subject needs to pay attention to the photographing apparatus 2, and thereby reduce the burden on the subject.

The face detection unit 11 detects the face of the subject from the image obtained by photographing the subject. More specifically, the face detection unit 11 acquires the image obtained by photographing the subject from the photographing control unit 16, and detects the face of the subject from the acquired image.

Note that the expression “to detect a face” in this specification means to specify a section including the face of the subject from an image obtained by photographing the subject. Further, the face detection unit 11 provides this section to the image quality determination unit 15 as an image of the face of the subject.

The face detection unit 11 may detect the face of the subject from the acquired image, for example, by dividing the acquired image into a plurality of sections and determining, for each of the sections, whether or not a part of or the whole face of the subject is included in the section. Further, the face detection unit 11 may include, for example, an artificial intelligence (AI, Artificial Intelligence) that has learned (i.e., has been trained by using) images of faces of human beings. Then, the face detection unit 11 may make the artificial intelligence read the acquired image and detect the face of the subject therein. That is, any of various technologies capable of detecting the face of a subject can be used for the face detection unit 11.

In a case where the face detection unit 11 detects the face of the subject from the image obtained by photographing the subject, it provides the image obtained by photographing the subject and information about the position of the face in this image to the area setting unit 12. Then, the face detection unit 11 provides the image of the detected face to the image quality determination unit 15.

Not that the above-described information about the position of the face in the image in this specification may be, for example, coordinate information of a section in which the face is shown in the aforementioned image. Further, the information about the position of the face in the image may be, for example, image data obtained by superimposing boundary lines of a section in which the face is shown on the aforementioned image.

Note that in a case where the face of the subject cannot be detected from the image obtained by photographing the subject, the face detection unit 11 may acquire a new image obtained by photographing the subject from the photographing control unit 16. Further, images may be repeatedly acquired until the face of the subject is detected. Further, the face detection unit 11 may repeatedly acquire an image from the photographing control unit 16 and attempt to detect the face therein until the output unit 14 (which will be described later) outputs information about the face of the subject and information about the hand thereof.

The area setting unit 12 acquires the image obtained by photographing the subject and information about the position of the face in this image from the face detection unit 11. Then, the area setting unit 12 sets a hand detection area around an area including the face of the subject based on the acquired information about the position of the face in the image.

Note that the above-described hand detection area in this specification is an area set in the image obtained by photographing the subject, and the hand detection unit 13 (which will described later) detects a hand of the subject in the hand detection area. That is, the area setting unit 12 limits the range in which the hand detection unit 13 detects a hand of the subject to an area around an area including the face of the subject. By the above-described configuration, the detection apparatus 1 can prevent a hand of a person other than the subject, shown in the acquired image from being mistakenly detected as a hand of the subject.

Further, the area setting unit 12 may set, as the hand detection area, an area that is, for example, centered at the center of the position of the face and has a predetermined horizontal width and a predetermined vertical width.

Note that in a case where the hand detection area is set, the detection system 102 may guide the subject to take such a posture that his/her hand is shown (i.e., positioned) in the hand detection area. In the detection system 102, in a case where the hand detection area is set, the display apparatus 3 may display, for example, the image of the subject and the hand detection area in a superimposed manner. Then, the detection system 102 may guide the subject to take such a posture that his/her hand is present in the hand detection area displayed by the display apparatus 3.

The hand detection unit 13 detects a hand present in the hand detection area from the image taken by the photographing apparatus. More specifically, the hand detection unit 13 acquires the image obtained by photographing the subject and position information of the hand detection area from the area setting unit 12. Then, the hand detection unit 13 detects a hand of the subject present in the hand detection area in the above-described image.

Note that the expression “to detect a hand” in this specification means to specify a section including a hand of a subject from an image obtained by photographing the subject. Further, the hand detection unit 13 provides this section to the image quality determination unit 15 as an image of the hand of the subject.

The hand detection unit 13 may detect a hand of the subject in the hand detection area in the acquired image by, for example, dividing the acquired image into a plurality of sections and determining, for each of sections present in the hand detection area, whether or not a part of or the whole hand of the subject is included in the section. Further, the hand detection unit 13 may include, for example, an artificial intelligence that has learned (i.e., has been trained by using) images of hands of human beings. Then, the hand detection unit 13 may make the artificial intelligence read the acquired image and detect a hand of the subject therein. That is, any of various technologies capable of detecting the face of a subject can be used for the hand detection unit 13.

In a case where the hand detection unit 13 detects a hand of the subject in the hand detection area, it provides the image of the detected hand to the image quality determination unit 15. Note that in a case where the face of the subject cannot be detected from the image obtained by photographing the subject, the face detection unit 11 may acquire a new image obtained by photographing the subject from the photographing control unit 16. Further, images may be repeatedly acquired until the face of the subject is detected. Further, the face detection unit 11 may repeatedly acquire an image from the photographing control unit 16 and attempt to detect the face therein until the output unit 14 (which will be described later) outputs information about the face of the subject and information about the hand thereof.

The image quality determination unit 15 acquires the image of the face of the subject from the face detection unit 11 and the image of the hand of the subject from the hand detection unit 13. The image quality determination unit 15 determines whether or not each of the acquired image of the face of the subject and the acquired image of the hand thereof has been taken (i.e., photographed) with image quality with which features having quality suitable for biometric authentication can be extracted.

The image quality determination unit 15 may evaluate, for example, the degree of blurriness and/or a CNR (Contrast to Noise Ratio) of the acquired image. Then, in a case where the degree of blurriness or the CNR of the acquired image is smaller than a predetermined threshold, the image quality determination unit 15 may determine that the acquired image (i.e., each of the acquired images) has been taken with image quality with which features having quality suitable for biometric authentication can be extracted. Note that the image quality determination unit 15 may determine the image quality of the acquired image by using an evaluation criterion other than the degree of blurriness and the CNR of the acquired image.

Further, the image quality determination unit 15 may determine whether each of an image of the face of the subject and an image of a hand thereof both of which have been detected from one image (i.e., from the same image) has been taken (i.e., photographed) with image quality with which features having quality suitable for biometric authentication can be extracted. That is, the image quality determination unit 15 may detect the image of the face of the subject acquired from the face detection unit 11 and the image of the hand of the subject acquired from the hand detection unit 13 from the same image (i.e., from one image).

By the above-described configuration, the detection system 102 can indicate that the acquired image of the face and the acquired image of the hand are related to each other. That is, the detection system 102 makes it possible to easily ensure that the image of the detected face and the image of the detected hand belong to the same person.

Further, in a case where the image quality determination unit 15 determines that each of the image of the detected face of the subject and the image of the detected hand thereof has not been taken (i.e., photographed) with image quality with which features having quality suitable for biometric authentication can be extracted, the image quality determination unit 15 may notify the photographing control unit 16 to that effect. In this case, the photographing control unit 16 may first perform image processing on the image obtained by photographing the subject, and then provide the image-processed image to the face detection unit 11 and the hand detection unit 13. The above-described image processing in this specification may be, for example, a process for adjusting the color (e.g., the hue) of the image. Further, the image processing may be a process for making a signal obtained by converting the image pass through a low-pass filter.

The output unit 14 outputs information about the face detected by the face detection unit 11 and information about the hand detected by the hand detection unit 13. More specifically, in a case where the image quality determination unit 15 determines that the image of the face of the subject and the image of the hand thereof have been taken (i.e., photographed) with image quality with which features having quality suitable for biometric authentication can be extracted, the output unit 14 outputs the image of the face to the authentication apparatus 4 as information about the face of the subject. Further, the output unit 14 outputs the image of the hand to the authentication apparatus 4 as information about the hand of the subject.

In a case where the output unit 14 outputs the information about the face detected by the face detection unit 11 and the information about the hand detected by the hand detection unit 13, it may notify the photographing control unit 16 that these pieces of information have been output. Further, in this case, the output unit 14 may also notify the face detection unit 11, the area setting unit 12, and the hand detection unit 13 that these pieces of information have been output.

### Processing of Detection System

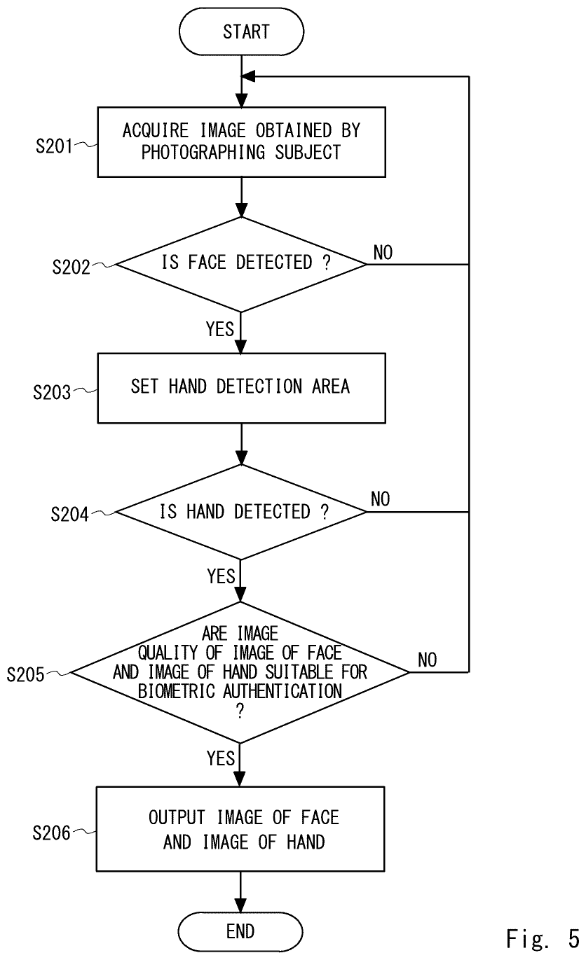

Next, processes, i.e., a detection method, performed by the detection system according to the second example embodiment will be described in detail with reference to the drawings. FIG. 5 is a flowchart showing processes performed by the detection system according to the second example embodiment. More specifically, FIG. 5 is a flowchart showing processes performed by the detection apparatus 1 according to the second example embodiment. Note that in the following description, FIG. 4 will be referred to as appropriate.

Firstly, the face detection unit 11 acquires an image obtained by photographing a subject (Step S201). More specifically, the face detection unit 11 acquires, from the photographing control unit 16, an image of a subject taken by the photographing apparatus 2.

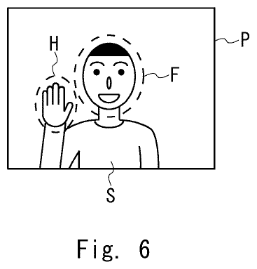

FIG. 6 is a schematic diagram showing an example of an image acquired by the face detection unit 11. The face detection unit 11 acquires an image P in which a subject S is shown as shown in FIG. 6. Note that the face detected by the detection apparatus 1 according to this example embodiment is the face F of the subject S shown in FIG. 6, and the hand detected by the detection apparatus 1 according to this example embodiment is a hand H of the subject S shown in FIG. 6.

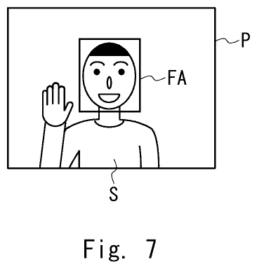

Next, the face detection unit 11 detects the face of the subject (Step S202). In the step S202, for example, the face detection unit 11 may specify a section FA including the face of the subject S as shown in FIG. 7, and provide the specified section FA as an image of the face of the subject S.

In the step S202, in a case where the face detection unit 11 has not been able to detect the face of the subject yet, the detection apparatus 1 performs the step S201 again. That is, the face detection unit 11 repeatedly performs the steps S201 and S202 until it detects the face of the subject.

In the step S202, in a case where the face detection unit 11 has detected the face of the subject (Yes in Step S203), the detection apparatus 1 proceeds to a step S203.

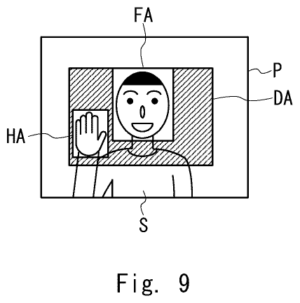

Next, the area setting unit 12 sets a hand detection area (Step S203). More specifically, the area setting unit 12 sets a hand detection area around an area including the face of the subject. Note that the expression “around an area including the face of a subject” in this specification may mean an area around a section FA including the face of a subject in an image obtained by photographing the subject. For example, as shown in FIG. 9, the area setting unit 12 may set a hand detection area DA so that it is adjacent to the section FA including the face of the subject S.

Next, the hand detection unit 13 detects a hand present in the hand detection area (Step S204). In a step S205, for example, the hand detection unit 13 may specify a section HA including a hand of the subject S as shown in FIG. 9, and provide the specified section HA as an image of the hand of the subject S.

In the step S204, in a case where the hand detection unit 13 has not been able to detect a hand of the subject yet (No in Step S204), the detection apparatus 1 performs the step S201 again. That is, the detection apparatus 1 repeatedly performs the steps S201 to S204 until it detects a hand of the subject. In the step S204, in a case where the hand detection unit 13 detects a hand of the subject (Yes in Step S204), the detection apparatus 1 proceeds to a step S205.

Next, the image quality determination unit 15 determines whether or not each of the image of the detected face and the image of the detected hand has image quality suitable for biometric authentication (Step S205).

In the step S205, in a case where the image of the detected face and the image of the detected hand do not have image quality suitable for biometric authentication (No in Step S205), the detection apparatus 1 performs the step S201 again. That is, the detection apparatus 1 repeatedly performs the steps S201 to S205 until an image of a detected face and an image of a detected hand both having image quality suitable for biometric authentication are obtained. In the step S205, in a case where the image of the detected face and the image of the detected hand have image quality suitable for biometric authentication (Yes in Step S205), the detection apparatus 1 proceeds to a step S206.

Lastly, the output unit 14 outputs each of the image of the detected face and the image of the detected hand (Step S206), and the detection apparatus 1 finishes the series of processes. Note that the output unit 14 may notify the photographing control unit 16 that the step S208 has been performed at a timing when the step S208 has been performed.

As described above, the detection system 102 according to this example embodiment detects the face of a subject and a hand thereof from an image obtained by photographing the subject.

The detection system 102 according to the present disclosure can be implemented in a case where at least the photographing apparatus 2 can photograph a subject to be photographed. According to the above-described configuration, the subject does not need to pay attention to two or more photographing apparatuses, i.e., a photographing apparatus that takes a face image and a photographing apparatus that takes a hand image. Therefore, the detection system 101 can reduce the burden on the subject.

Further, the detection system 102 according to this example embodiment sets, after detecting the face of a subject, a hand detection area around an area including the face of the subject. Then, the detection system 102 detects a hand present in the hand detection area. According to the above-described configuration, it is possible to prevent a hand of a person other than the subject shown in the image from being mistakenly detected as a hand of the subject.

### Third Example Embodiment

### Configuration of Detection System

A detection system according to a third example embodiment will be described hereinafter in detail with reference to the drawings. Firstly, a configuration of a detection system according to the third example embodiment will be described.

The detection system 102 according to the second example embodiment outputs an image of the face of a subject and an image of a hand of the subject as information about the face of the subject and information about the hand thereof. In contrast, a detection system 103 according to the third example embodiment outputs features of the face of a subject and features of a hand of the subject as information about the face of the subject and information about the hand thereof.

Similar to the detection system 102 according to the second example embodiment, the detection system 103 according to the third example embodiment includes a detection apparatus 1, a photographing apparatus 2, a display apparatus 3, and an authentication apparatus 4. That is, the detection system 103 according to the third example embodiment has a configuration similar to that shown in FIG. 3.

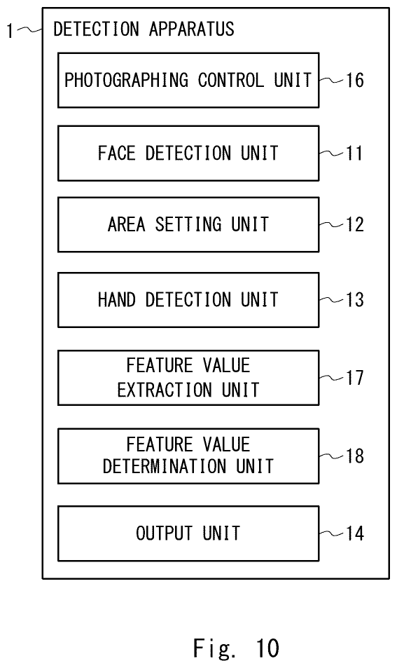

FIG. 10 is a block diagram showing a configuration of the detection apparatus 1 according to the third example embodiment. The detection system 103 according to the third example embodiment differs from the detection system 102 according to the second example embodiment in that the detection system 103 includes a feature extraction unit 17 and a feature determination unit 18 in place of the image quality determination unit 15.

The feature extraction unit 17 extracts features from each of the image of the face of the subject and the image of the hand thereof. More specifically, the feature extraction unit 17 acquires the image of the face of the subject from the face detection unit 11 and the image of the hand of the subject from the hand detection unit 13. Then, the feature extraction unit 17 extracts features of each of the face and the hand of the subject from the acquired images. The feature extraction unit 17 provides the extracted features to the feature determination unit 18.

Note that the above-described features in this specification mean data obtained by converting image data by any of various methods, and mean data with which a subject can be authenticated by comparing the data. For example, features may be expressed as numerical values or in a format other than numerical values. That is, features may be data in a format with which a subject can be authenticated.

Further, the feature extraction unit 17 may extract features of the face of a subject and those of a hand thereof from an image of the face of the subject and an image of a hand of the subject both of which have been detected from one image (i.e., from the same image).

By the above-described configuration, the detection system 103 can indicate that the acquired features of the face and those of the hand are related to each other. That is, the detection system 103 makes it possible to easily ensure that the features of the detected face and those of the hand belong to the same person.

The feature determination unit 18 determines whether or not the quality of the features extracted by the feature extraction unit 17 are suitable for biometric authentication. The feature determination unit 18 may evaluate, for example, the standard deviation of the extracted features. That is, the feature determination unit 18 may acquire a plurality of features and calculate a standard deviation thereof. Then, in a case where the standard deviation is equal to or smaller than a predetermined threshold, the feature determination unit 18 may determine that the extracted features have quality suitable for biometric authentication. However, the feature determination unit 18 may evaluate the quality of features by using an evaluation criterion other than the standard deviation.

In a case where the feature determination unit 18 determines that the features extracted by the feature extraction unit 17 have quality suitable for biometric authentication, it outputs these features to the output unit 14. In this case, the output unit 14, which have acquired the features, outputs the features as information about the face of the subject and information about the hand thereof.

Further, in a case where the feature determination unit 18 determines that the features extracted by the feature extraction unit 17 do not have quality suitable for biometric authentication, it may notify the face detection unit 11, the area setting unit 12, and the hand detection unit 13 to that effect. In this case, the face detection unit 11, the area setting unit 12, and the hand detection unit 13 may acquire a new image and perform the process for detecting the face and a hand of the subject again.

### Processing of Detection System

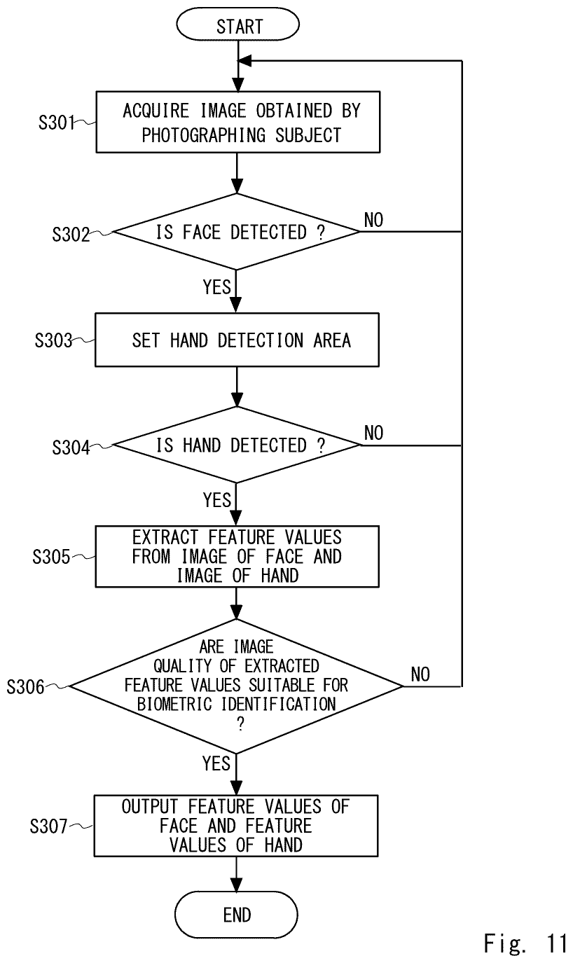

Next, processes, i.e., a method, performed by the detection system according to the third example embodiment will be described in detail with reference to the drawings. FIG. 11 is a flowchart showing processes performed by the detection system according to the third example embodiment. Note that in the following description, FIG. 10 will be referred to as appropriate.

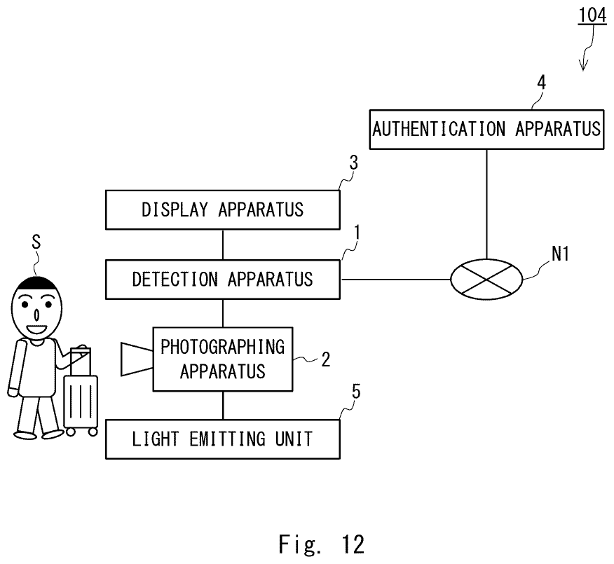

Note that since processes in steps S301 to S304 shown in FIG. 11 are similar to those in the steps S201 to S204 described in the second example embodiment, descriptions thereof will be omitted. That is, in the following description, processes shown in FIG. 12 performed by the detection apparatus 1 according to the third example embodiment, which correspond to processes that are performed in a case where the determination in the step S304 shown in FIG. 11 is Yes, will be described.

In a case where the hand detection unit 13 has detected a hand of the subject (Yes in Step S304), the feature extraction unit 17 detects features from the image of the detected face and the image of the detected hand (Step S305). Then, the feature determination unit 18 determines whether or not the extracted features have quality suitable for biometric authentication (Step S306).

In a case where the extracted features do not have quality suitable for biometric authentication (No in Step S306), the detection apparatus 1 performs the step S301 shown in FIG. 11 again. That is, the detection apparatus 1 repeatedly performs the steps S301 to S306 until features having quality suitable for biometric authentication are extracted.

In a case where the extracted features have quality suitable for biometric authentication (Yes in Step S306), the output unit 14 outputs the extracted features (Step S307), and the detection apparatus 1 finishes the series of processes. Note that the output unit 14 may notify the photographing control unit 16 that the step S307 has been performed at a timing when the step S307 has been performed.

As described above, the detection system 103 according to this example embodiment extracts features of the face of a subject and those of a hand thereof from an image obtained by photographing the subject. Then, the detection system 103 according to this example embodiment extracts features of the face of the subject and those of the hand thereof, and repeatedly photographs the subject until it outputs features having quality suitable for biometric authentication.

By the above-described configuration, the detection system according to this example embodiment can contribute to an improvement of a biometric information authentication system. Therefore, the detection system according to this example embodiment makes it possible to provide a detection system, a detection method, and a detection program capable of acquiring biometric information by which the subject can be accurately authenticated while reducing the burden on the subject.

### Fourth Example Embodiment

### Configuration of Detection System

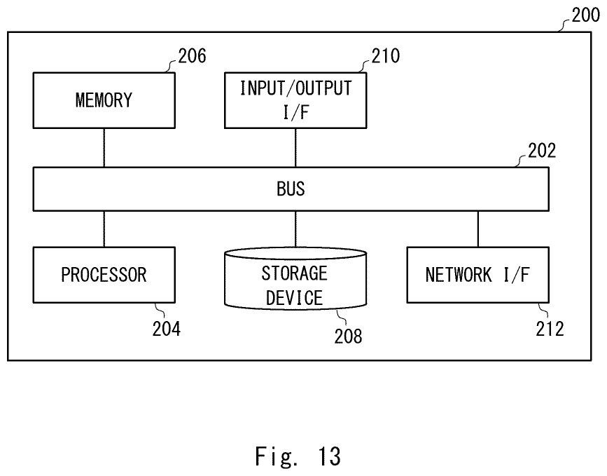

A detection system according to a fourth example embodiment will be described hereinafter in detail with reference to the drawings. FIG. 13 is a block diagram showing a configuration of a detection system according to the fourth example embodiment. A detection system 104 according to the fourth example embodiment is different from those in the above-described example embodiments in that the detection system 104 includes a light emitting unit 5. Note that the detection apparatus 1 according to this example embodiment may have a configuration similar to that in the second example embodiment. Alternatively, the detection apparatus 1 according to this example embodiment may have a configuration similar to that in the third example embodiment.

The light emitting unit 5 irradiates at least the hand detection area with light including a predetermined pattern image. For example, the light emitting unit 5 may irradiate only the hand detection area with light. Alternatively, the light emitting unit 5 may irradiate the whole body of the subject with light. Note that the pattern image means an image in which a number of predetermined patterns are shown. In a case where light including such an image is applied, it becomes difficult to photograph the irradiated area.

Further, the light emitting unit 5 blinks the light to be applied at a predetermined timing. That is, the light emitting unit 5 switches between a state in which the light is emitted and a state in which the light is not emitted at a predetermined timing. Note that the predetermined timing is also shared by (i.e., the predetermined timing is also known in) the photographing apparatus 2 or the photographing control unit 16.

Note that the photographing apparatus 2 photographs the subject at a timing when the light emitting unit 5 is not emitting light. Therefore, the photographing by the photographing apparatus 2 is not disturbed by the light emitted from the light emitting unit 5.

As described above, by having the photographing apparatus 2 or the photographing control unit 16 share (e.g., possess information about) the timing when no light is emitted, the light emitting unit 5 can prevent photographing apparatuses other than the photographing apparatus 2 from photographing the subject without preventing the photographing apparatus 2 from photographing the subject. As a result, the light emitting unit 5 can prevent, for example, a malicious third party from secretly photographing the subject or the like.

Further, the light emitting unit 5 may acquire, for example, information about the hand detection area from the detection apparatus 1. Then, the light emitting unit 5 may determine a range to which it applies light based on the acquired information about the hand detection area. Note that the aforementioned information about the hand detection area in this specification may be information about the position of the hand detection area.

For example, the information about the hand detection area may be information on the coordinates of the hand detection area. In the case where the acquired information about the hand detection area is information on the coordinates of the hand detection area, the light emitting unit 5 irradiates an area corresponding to the acquired coordinates with light.

By the above-described configuration, the detection system 104 can prevent a malicious third party from secretly taking an image in which the face and a hand of the subject are simultaneously shown. Therefore, the detection system 104 according to this example embodiment can provide a detection system, a detection method, and a detection program capable of acquiring biometric information by which the subject can be authenticated while reducing the burden on the subject under a highly-secured state.

### Example of Hardware Configuration

A case where each functional configuration of the detection system or the detection apparatus according to the present disclosure is implemented by a combination of hardware and software will be described hereinafter.

FIG. 14 is a block diagram showing an example of a hardware configuration of a computer. The management apparatus according to the present disclosure can implement the above-described functions by a computer 200 including the hardware configuration shown in FIG. 14. The computer 200 may be a portable computer such as a smartphone or a tablet-type terminal, or may be a stationary computer such as a PC (Personal Computer). The computer 200 may be a dedicated computer designed to implement a respective apparatus, or may be a general-purpose computer. The computer 200 can implement desired functions by installing therein a predetermined application(s).

The computer 200 include a bus 202, a processor 204, a memory 206, a storage device 208, an input/output interface (I/F) 210 and a network interface (I/F) 212. The bus 202 is a data transmission path through which the processor 204, the memory 206, the storage device 208, the input/output interface 210, and the network interface 212 transmit and receive data to and from each other. However, the method for connecting the processor 204 and the like to each other is not limited to connections through buses.

The processor 204 is any of various types of processors such as a CPU (Central Processing Unit), a GPU (Graphics Processing Unit), or an FPGA (Field-Programmable Gate Array). The memory 206 is a main storage device implemented by using a RAM (Random Access Memory) or the like.

The storage device 208 is an auxiliary storage device implemented by using a hard disk, an SSD (Solid State Drive), a memory card, a ROM (Read Only Memory), or the like. In the storage device 208, a program(s) for implementing desired functions is stored. The processor 204 implements each of functional components of each apparatus by loading this program onto the memory 206 and executing the loaded program.

The input/output interface 210 is an interface for connecting the computer 200 with an input/output device(s). For example, an input device such as a keyboard and an output device such as a display device are connected to the input/output interface 210.

The network interface 212 is an interface for connecting the computer 200 to a network.

Note that the program includes a set of instructions (or software codes) that, in a case where loaded onto a computer, causes the computer to perform one or a plurality of functions described in the example embodiments. The program may be stored in a non-transitory computer readable medium or in a physical storage medium. By way of example rather than limitation, a computer readable medium or a physical storage medium may include a RAM, a ROM, a flash memory, an SSD, or other memory technology, a CD-ROM, a DVD (Digital Versatile Disc), a Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Although the present disclosure has been described above with reference to the above-described example embodiments, the present disclosure is not limited to the configurations of the above-described example embodiments. Needless to say, the present disclosure includes various modifications, corrections, and combinations that can be made by a person skilled in the art within the scope of the claims.

The whole or part of the example embodiments disclosed above can be described as, but not limited to, the following supplementary notes.

### Supplementary Note 1

A detection system comprising:
a face detection unit configured to detect a face of a subject from an image obtained by photographing the subject;
an area setting unit configured to set, in a case where the face detection unit has detected the face of the subject, a hand detection area around an area including the face of the subject;
a hand detection unit configured to detect a hand present in the hand detection area from the image obtained by photographing the subject; and
an output unit configured to output information about the face of the subject detected by the face detection unit and information about the hand of the subject detected by the hand detection unit.

### Supplementary Note 2

The detection system described in Supplementary note 1, wherein the output unit outputs an image of the face of the subject as information about the face of the subject, and outputs an image of the hand of the subject as information about the hand of the subject.

### Supplementary Note 3

The detection system described in Supplementary note 2, further comprising an image quality determination unit configured to determine whether or not the image of the face of the subject and the image of the hand of the subject have been taken with image quality with which a feature having quality suitable for biometric authentication can be extracted, wherein
In a case where the image quality determination unit determines that the image of the face of the subject and the image of the hand of the subject have been taken with image quality with which a feature having quality suitable for biometric authentication can be extracted, the output unit outputs the image of the face of the subject as information about the face of the subject and outputs the image of the hand of the subject as information about the hand of the subject.

### Supplementary Note 4

The detection system described in Supplementary note 3, wherein the image quality determination unit determines whether or not the image of the face of the subject and the image of the hand of the subject both detected from one image have been taken with image quality with which a feature having quality suitable for biometric authentication can be extracted.

### Supplementary Note 5

The detection system described in any one of Supplementary notes 1 to 4, further comprising a feature extraction unit configured to extract a feature from each of the image of the face of the subject and the image of the hand thereof, wherein
the output unit outputs a feature extracted from the image of the face of the subject as information about the face of the subject, and outputs a feature extracted from the image of the hand of the subject as information about the hand of the subject.

### Supplementary Note 6

The detection system described in Supplementary note 5, further comprising a feature determination unit configured to determine whether or not a feature extracted by the feature extraction unit has quality suitable for biometric authentication, wherein
in a case where the feature determination unit determines that the feature has quality suitable for biometric authentication, the output unit outputs the feature as information about the face or the hand of the subject.

### Supplementary Note 7

The detection system described in any one of Supplementary notes 1 to 6, further comprising a light emitting unit configured to irradiate at least the hand detection area with light including a predetermined pattern image.

### Supplementary Note 8

The detection system described in any one of Supplementary notes 1 to 7, further comprising a display unit configured to display a reference posture image for urging the subject to take a predetermined posture in a case where the hand detection area is set.

### Supplementary Note 9

A detection method, wherein a computer:
detects a face of a subject from an image obtained by photographing the subject;
sets, upon detecting the face of the subject, a hand detection area around an area including the face of the subject;
detects a hand present in the hand detection area; and
outputs information about the detected face and information about the detected hand.

### Supplementary Note 10

The detection method described in Supplementary note 9, wherein the output unit outputs an image of the face of the subject as information about the face of the subject, and outputs an image of the hand of the subject as information about the hand of the subject.

### Supplementary Note 11

The detection method described in Supplementary note 10, further comprising an image quality determination unit configured to determine whether or not the image of the face of the subject and the image of the hand of the subject have been taken with image quality with which a feature having quality suitable for biometric authentication can be extracted, wherein
in a case where the image quality determination unit determines that the image of the face of the subject and the image of the hand of the subject have been taken with image quality with which a feature having quality suitable for biometric authentication can be extracted, the output unit outputs the image of the face of the subject as information about the face of the subject and outputs the image of the hand of the subject as information about the hand of the subject.

### Supplementary Note 12

The detection method described in Supplementary note 11, wherein the image quality determination unit determines whether or not the image of the face of the subject and the image of the hand of the subject both detected from one image have been taken with image quality with which a feature having quality suitable for biometric authentication can be extracted.

### Supplementary Note 13

The detection method described in any one of Supplementary notes 9 to 12, further comprising a feature extraction unit configured to extract a feature from each of the image of the face of the subject and the image of the hand thereof, wherein
the output unit outputs a feature extracted from the image of the face of the subject as information about the face of the subject, and outputs a feature extracted from the image of the hand of the subject as information about the hand of the subject.

### Supplementary Note 14

The detection method described in Supplementary note 13, further comprising a feature determination unit configured to determine whether or not a feature extracted by the feature extraction unit has quality suitable for biometric authentication, wherein
in a case where the feature determination unit determines that the feature has quality suitable for biometric authentication, the output unit outputs the feature as information about the face or the hand of the subject.

### Supplementary Note 15

The detection method described in any one of Supplementary notes 9 to 14, further comprising a light emitting unit configured to irradiate at least the hand detection area with light including a predetermined pattern image.

### Supplementary Note 16

The detection method described in any one of Supplementary notes 9 to 15, further comprising a display unit configured to display a reference posture image for urging the subject to take a predetermined posture in a case where the hand detection area is set.

### Supplementary Note 17

A non-transitory computer readable medium storing a program for causing a computer to perform a method comprising:
detecting a face of a subject from an image obtained by photographing the subject;
setting, upon detecting the face of the subject, a hand detection area around an area including the face of the subject;
detecting a hand present in the hand detection area; and
outputting information about the detected face and information about the detected hand.

This application is based upon and claims the benefit of priority from Japanese patent application No. 2022-085727, filed on May 26, 2022, the disclosure of which is incorporated herein in its entirety by reference.

### REFERENCE SIGNS LIST

1 DETECTION APPARATUS
2 PHOTOGRAPHING APPARATUS
3 DISPLAY APPARATUS
4 AUTHENTICATION APPARATUS
5 LIGHT EMITTING UNIT
11 FACE DETECTION UNIT
12 AREA SETTING UNIT
13 HAND DETECTION UNIT
14 OUTPUT UNIT
15 IMAGE QUALITY DETERMINATION UNIT
16 PHOTOGRAPHING CONTROL UNIT
17 FEATURE EXTRACTION UNIT
18 FEATURE DETERMINATION UNIT
101-104 DETECTION SYSTEM
200 COMPUTER
202 BUS
204 PROCESSOR
206 MEMORY
208 STORAGE DEVICE
210 INPUT/OUTPUT INTERFACE
212 NETWORK INTERFACE

What is claimed is:

1. A detection system comprising:
at least one memory storing instructions, and
at least one processor configured to execute the instructions to:
detect a face of a subject from an image obtained by photographing the subject;
set, in a case where the face of the subject has been detected, a hand detection area around an area including the face of the subject;
detect a hand present in the hand detection area from the image obtained by photographing the subject; and
output information about the face of the subject and information about the hand of the subject.

2. The detection system according to claim 1, wherein the at least one processor is further configured to execute the instructions to:
output an image of the face of the subject as information about the face of the subject; and
output an image of the hand of the subject as information about the hand of the subject.

3. The detection system according to claim 2, wherein the at least one processor is further configured to execute the instructions to:
determine whether or not the image of the face of the subject and the image of the hand of the subject have been taken with image quality with which a feature having quality suitable for biometric authentication can be extracted; and
in a case where the image of the face of the subject and the image of the hand of the subject have been taken with image quality with which a feature having quality suitable for biometric authentication can be extracted, output the image of the face of the subject as information about the face of the subject and output the image of the hand of the subject as information about the hand of the subject.

4. The detection system according to claim 3, wherein the at least one processor is further configured to execute the instructions to determine whether or not the image of the face of the subject and the image of the hand of the subject both detected from one image have been taken with image quality with which a feature having quality suitable for biometric authentication can be extracted.

5. The detection system according to claim 1, the at least one processor is further configured to execute the instructions to:
extract a feature from each of the image of the face of the subject and the image of the hand thereof;
output a feature extracted from the image of the face of the subject as information about the face of the subject; and
output a feature extracted from the image of the hand of the subject as information about the hand of the subject.

6. The detection system according to claim 5, the at least one processor is further configured to execute the instructions to:
determine whether or not a feature extracted by the feature extraction means has quality suitable for biometric authentication, and
in a case where the feature has quality suitable for biometric authentication, output the feature as information about the face or the hand of the subject.

7. The detection system according to claim 1, further comprising light emitting unit configured to irradiate at least the hand detection area with light including a predetermined pattern image.

8. The detection system according to claim 1, further comprising display apparatus configured to display a reference posture image for urging the subject to take a predetermined posture in a case where the hand detection area is set.

9. A detection method, wherein a computer:
detects a face of a subject from an image obtained by photographing the subject;
sets, upon detecting the face of the subject, a hand detection area around an area including the face of the subject;
detects a hand present in the hand detection area; and
outputs information about the detected face and information about the detected hand.

10. The detection method according to claim 9, wherein the computer outputs an image of the face of the subject as information about the face of the subject, and outputs an image of the hand of the subject as information about the hand of the subject.

11. The detection method according to claim 10, wherein the computer:
determines whether or not the image of the face of the subject and the image of the hand of the subject have been taken with image quality with which a feature having quality suitable for biometric authentication can be extracted;
in a case where the image of the face of the subject and the image of the hand of the subject have been taken with image quality with which a feature having quality suitable for biometric authentication can be extracted, outputs the image of the face of the subject as information about the face of the subject and outputs the image of the hand of the subject as information about the hand of the subject.

12. The detection method according to claim 11, wherein the computer determines whether or not the image of the face of the subject and the image of the hand of the subject both detected from one image have been taken with image quality with which a feature having quality suitable for biometric authentication can be extracted.

13. The detection method according to claim 9, wherein the computer:
extracts a feature from each of the image of the face of the subject and the image of the hand thereof;
outputs a feature extracted from the image of the face of the subject as information about the face of the subject; and
outputs a feature extracted from the image of the hand of the subject as information about the hand of the subject.

14. The detection method according to claim 13, wherein the computer:
determines whether or not a feature extracted by the feature extraction means has quality suitable for biometric authentication;
in a case where the feature has quality suitable for biometric authentication, outputs the feature as information about the face or the hand of the subject.

15. The detection method according to claim 9, further comprising irradiating at least the hand detection area with light including a predetermined pattern image.

16. The detection method according to claim 9, further comprising displaying a reference posture image for urging the subject to take a predetermined posture in a case where the hand detection area is set.

17. A non-transitory computer readable medium storing a program for causing a computer to perform a method comprising:
detecting a face of a subject from an image obtained by photographing the subject;
setting, upon detecting the face of the subject, a hand detection area around an area including the face of the subject;
detecting a hand present in the hand detection area; and
outputting information about the detected face and information about the detected hand.
